(19) United States
(12) Patent Application Publication
(10) Pub. No.: US 2026/0111903 A1
(43) Pub. Date: Apr. 23, 2026

(54) PORTAL MANAGEMENT PLATFORM

(71) Applicant: H. Hicks & Company, Inc., Royal Oak, MI (US)

(72) Inventor: Matthew H. Hicks, Washington, MI (US)

(21) Appl. No.: 18/920,830

(22) Filed: Oct. 18, 2024

(51) Int. Cl. G06Q 30/012; G06Q 10/20

(52) U.S. Cl. CPC G06Q 30/012; G06Q 10/20

(57) ABSTRACT

A portal management platform provides the ability to manage a large number of portals of a building. The portal management platform provides the ability to create physical asset records and connect or associate codes therewith, such as QR codes. The portal management platform provides the ability to create audit records, maintenance records, and service requests. The portal management platform provides the ability to audit a large number of portals in a building via a map interface, from which the status and specifications of portals can be updated.

### BACKGROUND

“Portals” of buildings include the doors themselves, the associated hardware, the frames, and the immediately adjacent wall portions. The portals may also include associated electronics such as security electronics, access restrictions, etc. The portals may include interior and exterior portals.

Portals are important physical assets in terms of ensuring the security of a building or other facility. Even moderately-sized facilities can have a large number of interior and exterior portals that are difficult to manage in terms of maintenance. Additionally, quality doors, frames, hardware, and electronics may come with manufacturer warranties, but the sheer number of portals in a facility may make it practically impossible to keep track of the warranties of everything, many of which would have different expiration dates.

### SUMMARY

A portal management platform provides the ability to manage a large number of portals of a building, including the doors themselves, the associated hardware, the frames, and the immediately adjacent wall portions. The portals also include associated electronics such as security electronics, access restrictions, etc. The portal management platform assists in managing the warranties and maintenance for each of these components. The portal management platform provides the ability to create physical asset records and connect or associate codes therewith, such as QR codes. The portal management platform provides the ability to create audit records, maintenance records, and service requests. The portal management platform provides the ability to audit a large number of portals in a building via a map interface, from which the status and specifications of portals can be updated.

In some aspects, the techniques described herein relate to a system for generating a new asset record for a physical asset, wherein the physical asset is a portal, the system including: at least one server sending a physical asset index webpage to a remote smart device, the physical asset index webpage having a create new asset selection button therein; the at least one server sending a new physical asset dialogue webpage to the remote smart device when the at least one server receives a first message indicating the create new asset selection button was selected on the physical asset index webpage; the new physical asset dialogue webpage having a physical asset type input textbox, a dimension input textbox, a composition input textbox, and a save selection button; the at least one server storing information entered into the physical asset type input textbox, the dimension input textbox, the composition input textbox of the new physical asset dialogue webpage in a new asset record in a physical asset table in a memory device, when the at least one server receives a second message indicating the save selection button was selected; the at least one server sending a physical asset summary webpage associated with the physical asset to the remote smart device when the at least one server receives a third message indicating a selectable record on the physical asset index webpage associated with the new asset record in the physical asset table was selected on the physical asset index webpage; the at least one server sending a QR connection webpage to the remote smart device when the at least one server receives a fourth message indicating a connect QR code selection button was selected on the physical asset summary webpage; the at least one server receiving a fifth message having a QR ID associated with a QR code; and the at least one server storing a new QR record in a QR table having the QR ID and an asset ID that are associated with the new asset record in a physical asset table in the memory device.

In some aspects, the techniques described herein relate to a system, wherein: the new physical asset dialogue webpage further having an install date input textbox and a warranty expiration input textbox; and the at least one server storing information entered into the install date input textbox and the warranty expiration input textbox of the new physical asset dialogue webpage in the memory device, when the at least one server receives the second message indicating the save selection button was selected on the new physical asset dialogue webpage.

In some aspects, the techniques described herein relate to a system wherein the portal includes a door.

In some aspects, the techniques described herein relate to a system for generating an audit record associated with a physical asset, wherein the physical asset is a portal, the system including: at least one server receiving a first message having a QR ID associated with a physical asset; the at least one server determining an asset ID based on the QR ID when the at least one server receives the first message; the at least one server sending a physical asset summary webpage associated with the asset ID to a remote smart device, the physical asset summary webpage having a new audit selection button therein; the at least one server sending a physical asset specification webpage associated with the asset ID to the remote smart device when the at least one server receives a second message indicating the new audit selection button was selected on the physical asset summary webpage, the physical asset specification webpage having at least one input textbox, a choose files image button, and a next selection button therein; and the at least one server storing information entered into the at least one input textbox of the physical asset specification webpage, and a current audit date in a record in a physical asset table in a memory device, and storing an image file selected using the choose files image button in the memory device, when the at least one server receives a third message indicating the next selection button was selected on the physical asset specification webpage.

In some aspects, the techniques described herein relate to a system wherein the portal includes a door.

In some aspects, the techniques described herein relate to a system for generating a maintenance record associated with a physical asset, wherein the physical asset is a portal, the system including: at least one server receiving a first message having a QR ID associated with a physical asset; the at least one server determining an asset ID based on the QR ID when the at least one server receives the first message; the at least one server sending a physical asset summary webpage associated with the asset ID to a remote smart device, the physical asset summary webpage having a new maintenance event selection button therein; the at least one server sending a maintenance event creation webpage associated with the asset ID to the remote smart device when the at least one server receives a second message indicating the new maintenance event selection button was selected on the physical asset summary webpage, the maintenance event creation webpage having a user name input textbox, an email address input textbox, a location input textbox, a maintenance performed input textbox, a choose files image button, and a submit selection button therein; and the at least one server storing information entered into the user name input textbox, the email address input textbox, the location input textbox, the maintenance performed input textbox in a maintenance record in a maintenance request table in a memory device, and storing an image file selected using the choose files image button in the memory device, when the at least one server receives a third message indicating the submit selection button was selected on the maintenance event creation webpage.

In some aspects, the techniques described herein relate to a system, wherein: the maintenance event creation webpage further having a warranty expiration input textbox; and the at least one server storing information entered into the warranty expiration input textbox in the maintenance record in the maintenance request table in the memory device.

In some aspects, the techniques described herein relate to a system, wherein: the at least one server sending a maintenance event summary webpage associated with the asset ID to the remote smart device when the third message was received by the at least one server, the maintenance event summary webpage having a date of maintenance field, a user name field indicating a name of a person who performed maintenance on the physical asset, a notes field, a warranty expiration date field, and the image file selected using the choose files image button of the maintenance event creation webpage.

In some aspects, the techniques described herein relate to a system, wherein: the at least one server sending a maintenance event email to an email address indicated in the email address input textbox of the maintenance event creation webpage when the at least one server receives the third message indicating the submit selection button was selected on the maintenance event creation webpage, the maintenance event email having information entered into the user name input textbox, the location input textbox, and the maintenance performed input textbox.

In some aspects, the techniques described herein relate to a system wherein the portal includes a door.

### BRIEF DESCRIPTION OF THE DRAWINGS

FIG. 1 is a schematic of a door management platform.

FIG. 2 is a physical asset index webpage of the door management platform of FIG. 1.

FIG. 3 is a new physical asset dialogue webpage of the door management platform of FIG. 1.

FIG. 4 is a physical asset supplemental webpage of the door management platform of FIG. 1.

FIG. 5 is a physical asset summary webpage of the door management platform of FIG. 1.

FIG. 6 shows a QR connection page of the door management platform of FIG. 1.

FIG. 7 shows a door hingeably connected to frame having an associated QR code adhered thereto.

FIG. 8 is a physical asset specification webpage of the door management platform of FIG. 1.

FIG. 9 is a physical asset summary webpage of the door management platform of FIG. 1.

FIG. 10 is a maintenance event creation webpage of the door management platform of FIG. 1.

FIG. 11 is a maintenance event summary webpage of the door management platform of FIG. 1.

FIG. 12 is a maintenance event email of the door management platform of FIG. 1.

FIG. 13 is a service request creation webpage of the door management platform of FIG. 1.

FIG. 14 is a first service request email of the door management platform of FIG. 1.

FIG. 15 is a second service request email of the door management platform of FIG. 1.

FIG. 16 is a physical asset table of the door management platform of FIG. 1.

FIG. 17 is a QR table of the door management platform of FIG. 1.

FIG. 18 is a maintenance request table of the door management platform of FIG. 1.

FIG. 19 is a physical asset table of the door management platform of FIG. 1.

FIG. 20 is a service request table of the door management platform of FIG. 1.

FIG. 21 is a map selection webpage of the door management platform of FIG. 1.

FIG. 22 is a map webpage of the door management platform of FIG. 1.

FIG. 23 is an edit map point webpage of the door management platform of FIG. 1.

FIG. 24 is a physical address database of the door management platform of FIG. 1.

FIG. 25 is a physical address table of the door management platform of FIG. 1.

FIG. 26 is a map database of the door management platform of FIG. 1.

FIG. 27 is a map asset database of the door management platform of FIG. 1.

FIG. 28 is a flowchart showing creation of a physical asset record.

FIG. 29 is a flowchart showing creation of an audit record.

FIG. 30 is a flowchart showing creation of a maintenance record.

FIG. 31 is a flowchart showing creation of a service request record.

FIG. 32 is a flowchart showing creation of a physical asset icon on a map.

### DETAILED DESCRIPTION

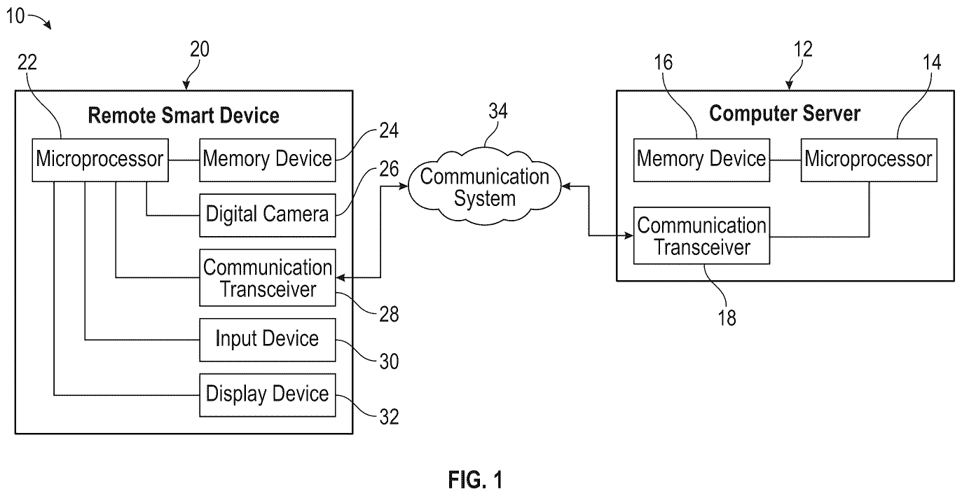

FIG. 1 is a schematic of a portal management platform 10 according to an example embodiment. The portal management platform 10 includes at least one server 12 having at least one processor 14, at least one memory 16, and at least one communication transceiver 18. The at least one memory 16 stores data as explained below and stores instructions, which when executed by the at least one processor 14 cause the portal management platform 10 to perform the operations described below.

The portal management platform 10 also includes at least one (and more likely, many) remote smart device 20. The remote smart device 20 includes at least one processor 22, at least one memory 24, at least one digital camera 26, and at least one communication transceiver 28. The remote smart device 20 further includes at least one input device 30 and at least one display 32. The at least one display 32 may be a touchscreen that also provides the at least one input device 30. The at least one memory 24 stores data as explained below and stores instructions, which when executed by the at least one processor 22 cause the portal management platform 10 to perform the operations described below. The remote smart device 20 may be a smart phone, tablet, or the like, such as an iPhone.

The at least one communication transceiver 28 may include wifi, cell data, Bluetooth, or other wireless networking communication circuits. The at least one communication transceiver 28 may also include an NFC (near-field communication) chip.

The portal management platform 10 includes a communication system 34, such as a network, which could be a local network, but more preferably is a wide-area network, such as the internet. The communication transceivers 18, 28 are capable of communicating with one another via the communication system 34.

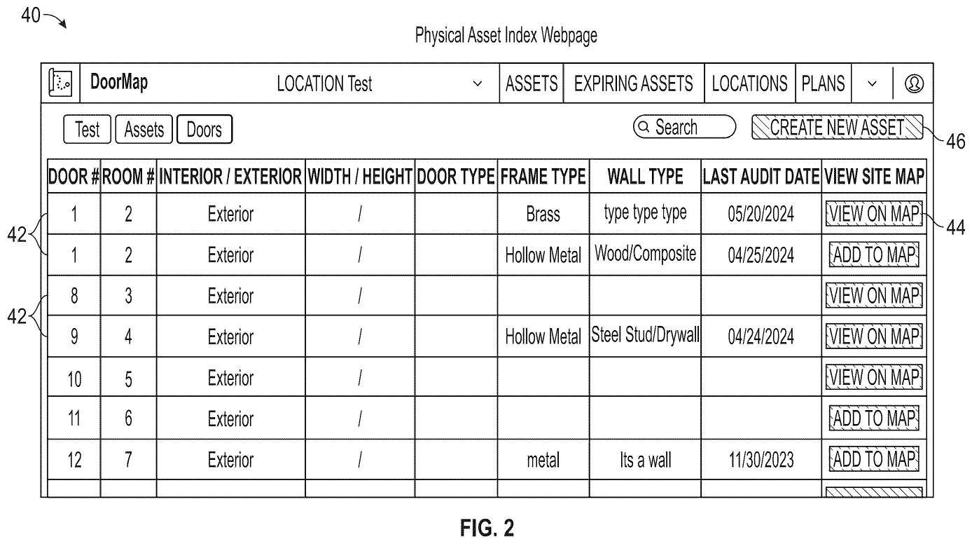

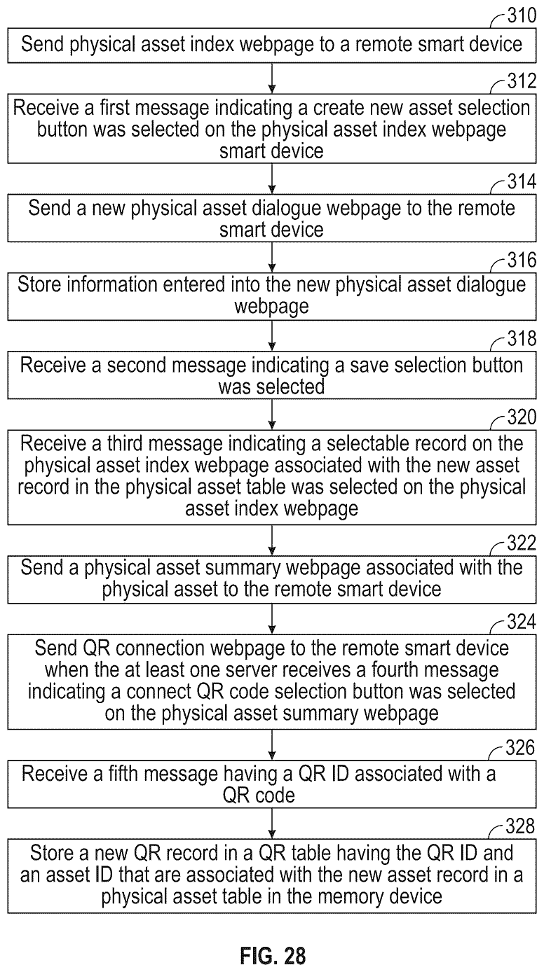

Referring to FIGS. 2 and 28, a user operating the remote smart device 20 requests and the at least one server 12 sends a physical asset index webpage 40 to the remote smart device 20 (step 310). The physical asset index webpage 40 is displayed on the at least one display 32 of the remote smart device 20. The physical asset index webpage 40 includes a list of previously stored physical assets 42, including basic information about each of the physical assets 42.

In this example, the physical assets are portals associated with facilities, such as buildings. “Portals” include the doors themselves, the associated hardware, the frames, and the immediately adjacent wall portions. The portals may also include associated electronics such as security electronics, access restrictions, etc. The portals include interior and exterior portals.

A view on map link 44 (e.g. in the form of a button) is provided in the list associated with each of the physical assets 42. The physical asset index webpage 40 also provides a create new asset link 46 (e.g. in the form of a button). When the user activates the create new asset link 46 (such as by touching the button on the at least one display 32 of the remote smart device 20), the remote smart device 20 sends a request for a new physical asset dialogue webpage 50 to the at least one server 12. The at least one server 12 receives the request (step 312) and sends a new physical asset dialogue webpage 50 to the remote smart device 20 (step 314).

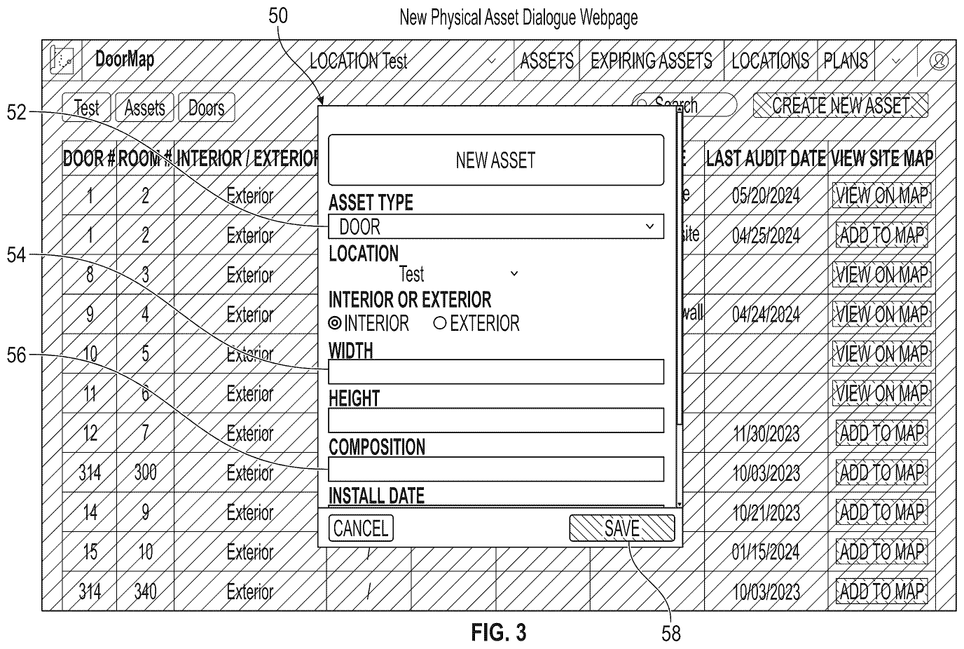

The new physical asset dialogue webpage 50 is shown in FIG. 3 as displayed on the at least one display 32 of the remote smart device 20. The new physical asset dialogue webpage 50 may be a pop-up window over the physical asset index webpage 40 as shown. The new physical asset dialogue webpage 50 includes a physical asset type input textbox 52, which may be a pull-down list (as shown) or a free text entry field. The new physical asset dialogue webpage 50 further includes dimension input textboxes 54 (e.g. width and height) and a composition input textbox 56 (which could be a pull-down list or free text entry field). The new physical asset dialogue webpage 50 further includes a save button 58. When the save button 58 is activated, an indication is received by the at least one server 12 (step 316). In response, the at least one server 12 stores the information entered on the new physical asset dialogue webpage 50 to the at least one memory 16 (step 318). Activating the save button 58 may also cause the at least one server 12 to send to the remote smart device 20 a physical asset supplemental webpage 60.

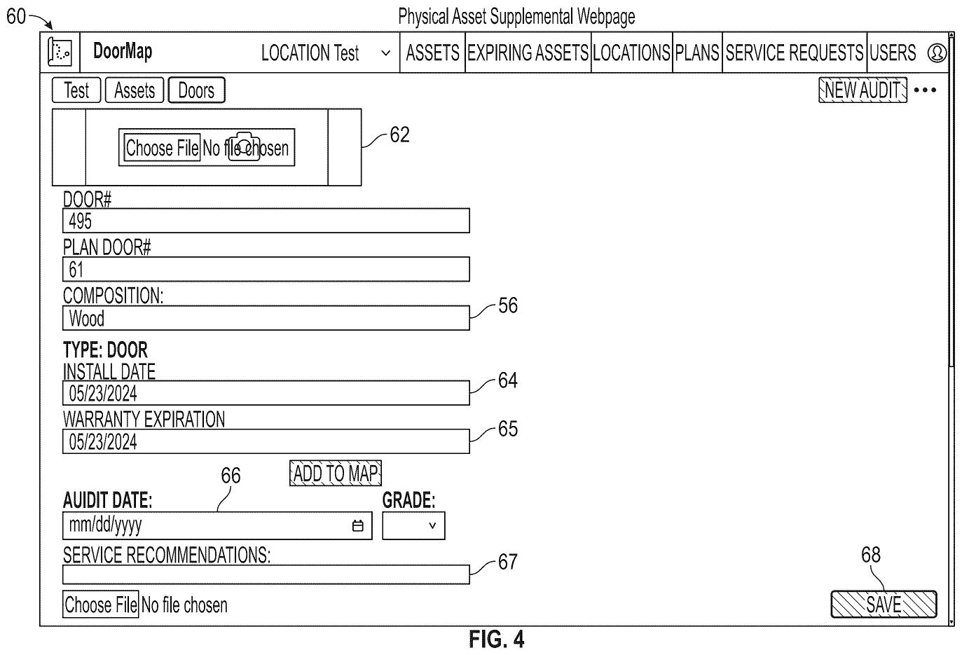

The remote smart device 20 displays the physical asset supplemental webpage 60 on the at least one display 32 as shown in FIG. 4. The physical asset supplemental webpage 60 includes a choose files image button 62, an install date input textbox 64 (which could be a calendar pop-up or a free text entry field), a warranty expiration input textbox 65 (which could be a calendar pop-up or a free text entry field), an audit date input textbox 66 (which could be a calendar pop-up or a free text entry field), and a service recommendation input textbox 67. The physical asset supplemental webpage 60 further includes a save button 68, which when activated saves the input data to the at least one memory 16.

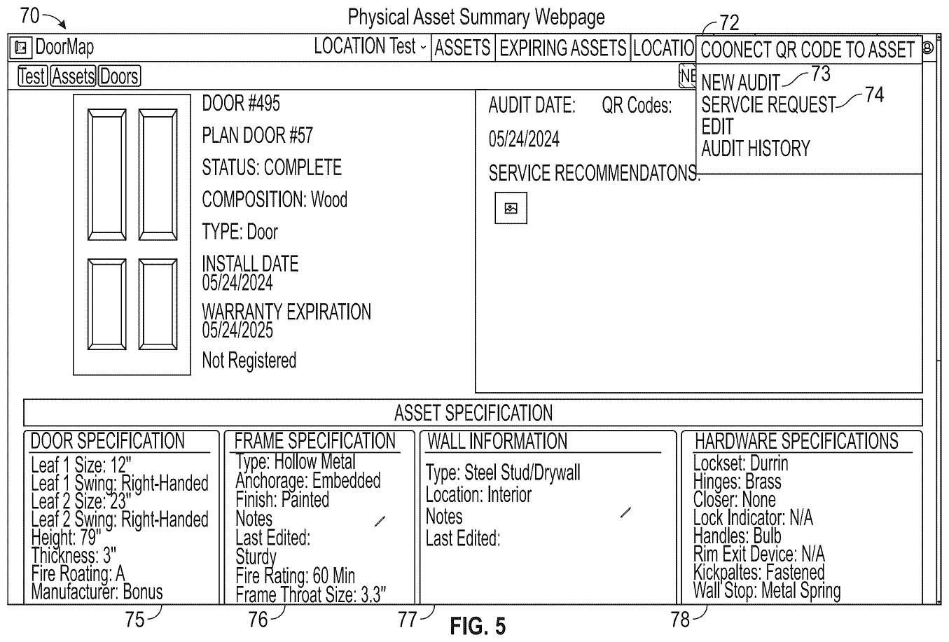

FIG. 5 is a physical asset summary webpage 70 of the portal management platform 10 of FIG. 1. The user can cause the remote smart device 20 to request the physical asset summary webpage 70 from the at least one server 12. The at least one server 12 receives the request (step 320) and in response sends the physical asset summary webpage 70 (step 322) to the remote smart device 20 automatically after the save button 68 (FIG. 4) is activated. The at least one server 12 sends the physical asset summary webpage 70 to the remote smart device 20, which then displays the physical asset summary webpage 70 as shown in FIG. 5.

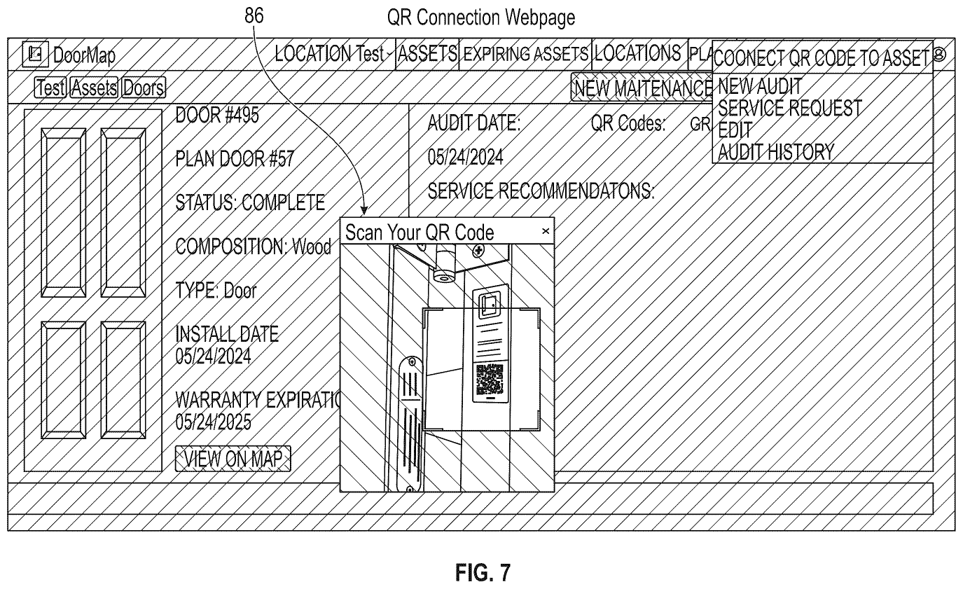

The physical asset summary webpage 70 includes a connect QR code selection button 72, a new audit button 73, a service request button 74, and an edit button, which may be in a pull-down menu as shown. The physical asset summary webpage 70 also displays a door specification summary 75, a frame specification summary 76, a wall information summary 77, and a hardware specification summary 78, all associated with the specific door. When the user activates the connect QR code selection button 72 on the physical asset summary webpage 70, the remote smart device 20 sends a request that is received by the at least one server 12. In response, the at least one server 12 sends a QR connection webpage 86 (step 324), which may be a pop-up over the physical asset summary webpage 70 as shown in FIG. 7.

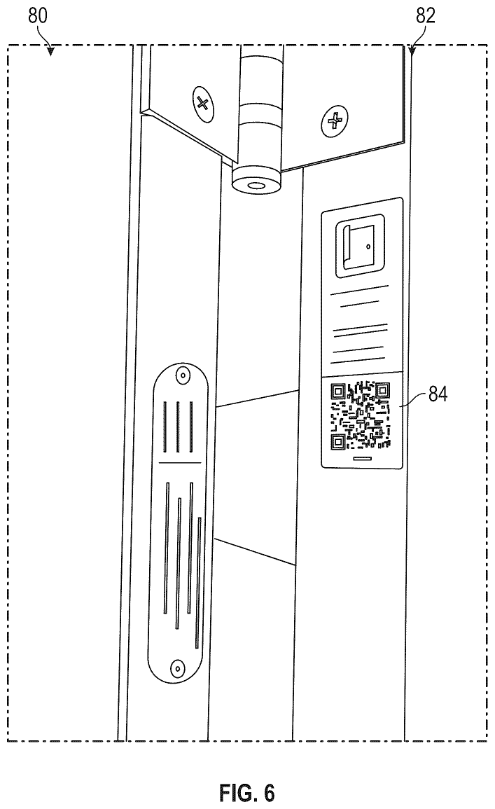

FIG. 6 shows a door 80 hingeably connected to frame 82 having an associated QR code 84 adhered thereto (e.g. placed by the user). Other physical asset tags could also be used, such as barcodes, RFIDs, NFC chips, or the like.

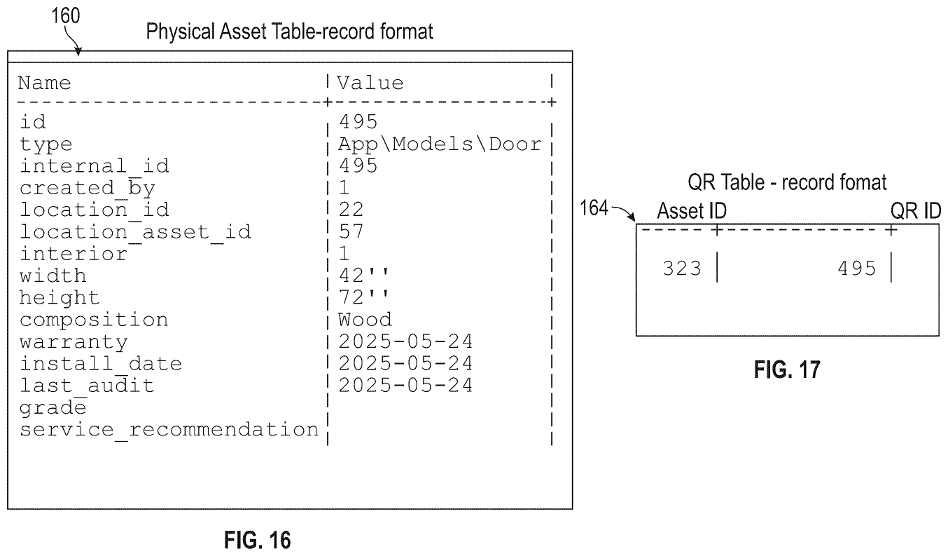

The user then aligns the at least one digital camera 26 of the remote smart device 20 with a QR code 84 mounted proximate a door 80 and/or frame 82, for which the user has been entering information. The remote smart device 20 sends the QR code which is received by the at least one server 12 (step 326), which then stores the QR code (or the QR ID associated with the QR code) with the new physical asset (the door 80) that is then stored in the at least one memory 16 and the physical asset index webpage 40 (FIG. 2). The at least one server 12 stores a new QR record in a QR table (FIG. 17) having the QR ID and the asset ID that are associated with the new asset record (i.e. the door 80) in a physical asset table (FIG. 16) in the at least one memory 16 (step 328).

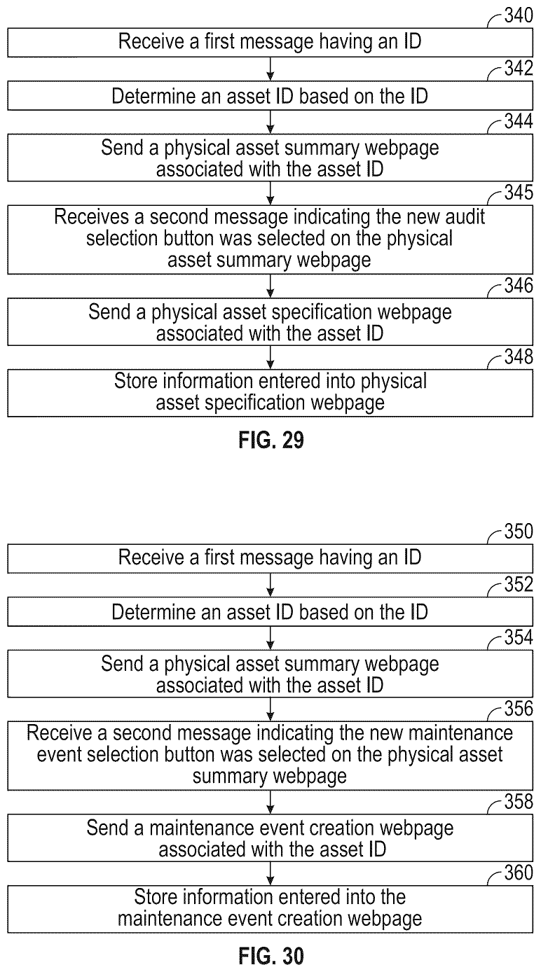

Referring to FIG. 29, if the user activates the new audit button 73 from the physical asset summary webpage 70 (FIG. 5) (step 345), the user scans the QR code associated with a specific physical asset (door). The at least one server 12 receives the QR ID (step 340) when the QR code is scanned by the remote smart device 20. The at least one server 12 determines the asset ID based upon the QR ID (step 342).

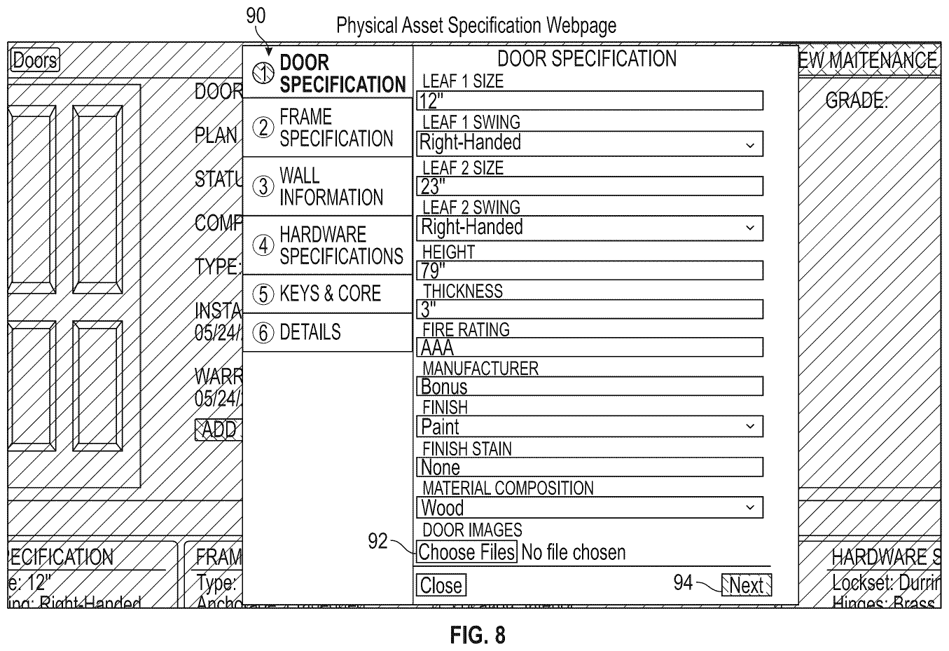

A physical asset specification webpage 90 is requested from the remote smart device 20. The at least one server 12 sends the physical asset specification webpage 90 (step 346), which is displayed on the at least one display 32 of the remote smart device 20 as shown in FIG. 8. The physical asset specification webpage 90 may be a popup window as shown. The physical asset specification webpage 90 displays door specifications (as shown) in input textboxes, which may be modified by the user. The physical asset specification webpage 90 also displays a choose files image button 92 and a next button 94. If the user activates the choose files image button 92, the user can use the at least one digital camera 26 on the remote smart device 20 to take pictures of the door 80, frame 82, or associated walls or surrounding area that will then be associated with the door 80 in the at least one memory 16. The at least one server 12 stores this information in the at least one memory 16 (step 348).

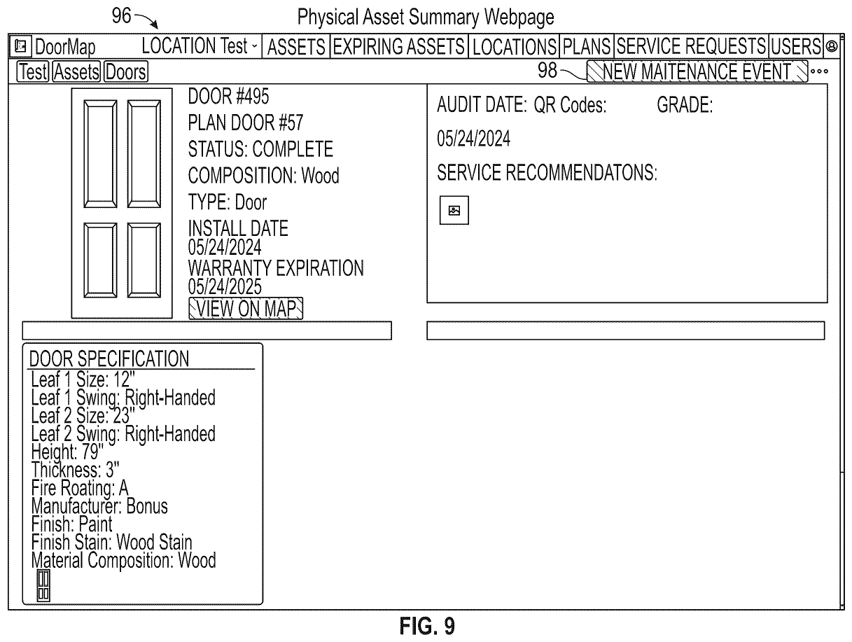

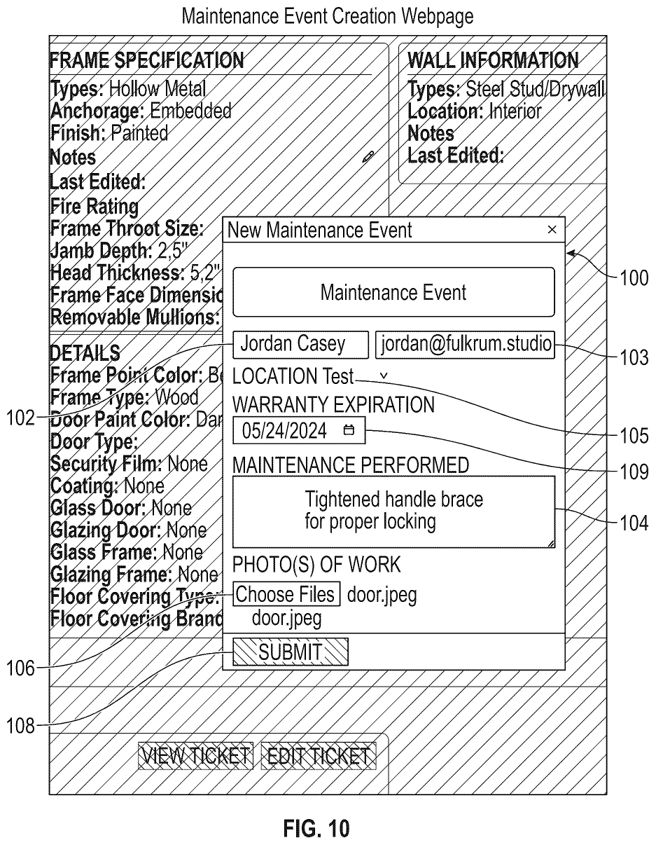

FIG. 9 is a physical asset summary webpage 96 of the door management platform of FIG. 1. Referring also to FIG. 30, if the user scans a QR code coupled to a physical asset (e.g. door) with the remote smart device 20, the QR ID is sent to the at least one server 12 (step 350). The at least one server 12 determines an asset ID associated with the QR ID (step 352). The physical asset summary webpage 96 may be requested by the remote smart device 20, sent by the at least one server 12 and displayed on the at least one display 32 of the remote smart device 20. The physical asset summary webpage 96 displays summary information of the door 80, including an image of the door 80. The physical asset summary webpage 96 also provides a new maintenance event selection button 98. If the user activates the new maintenance event selection button 98 on the at least one display 32 of the remote smart device 20, the at least one server 12 receives a message from the remote smart device 20 that the new maintenance event selection button 98 has been selected (step 356). In response, the at least one server 12 sends, and the remote smart device 20 displays, a maintenance event creation webpage 100 (step 358), which is shown in FIG. 10.

The maintenance event creation webpage 100 may be a popup window as shown. The maintenance event creation webpage 100 provides a user name input textbox 102 and an email address input textbox 103 both identifying the creator of the maintenance event. The maintenance event creation webpage 100 also provides a maintenance performed input textbox 104, which permits the user to enter a short description of the maintenance that was performed on the associated door 80, door frame 82 or associated walls. The maintenance event creation webpage 100 also provides a location input textbox 105 (which may be a pulldown menu, a free text entry field, or may already be populated from information associated with the physical asset (door) for which the maintenance event was created (FIG. 9)).

The maintenance event creation webpage 100 also provides choose files image button 106 that enables the user to take an image using the at least one digital camera 26 of the remote smart device 20 of the maintenance performed. The maintenance event creation webpage 100 also provides a submit selection button 108, which sends the information to the at least one server 12 to be stored in at least one memory 16 associated with the physical asset (e.g. the door 80). The maintenance event creation webpage 100 also includes a warranty expiration date input textbox 109 (which may be a calendar popup or a free entry text field).

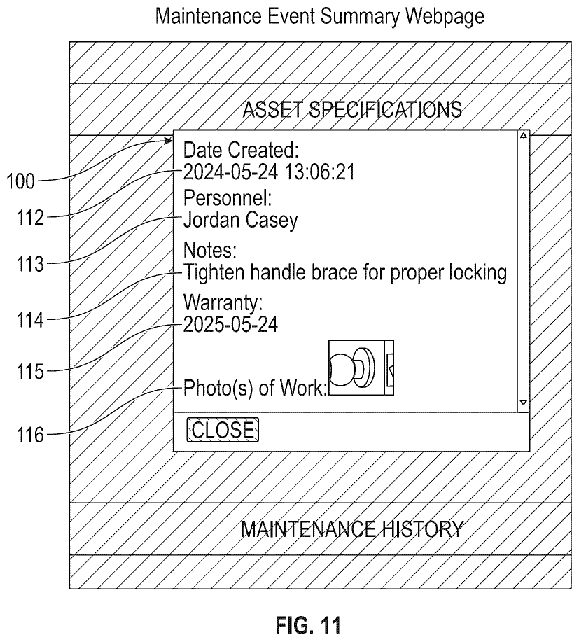

When the submit selection button 108 is activated by the user on the at least one display 32 of the remote smart device 20, the at least one server 12 stores the information that was entered into the maintenance event creation webpage 100 (step 360) and sends to the remote smart device 20 a maintenance event summary webpage 110, which is shown in FIG. 11 as displayed on the at least one display 32 of the remote smart device 20.

FIG. 11 shows the maintenance event summary webpage 110. The maintenance event summary webpage 110 includes a date of maintenance field 112 (when the maintenance was performed), a user name field 113 (who performed the maintenance on the physical asset), a notes field 114, a warranty expiration date field 115, and an image file 116 (one of the image(s) uploaded by the user who performed the maintenance).

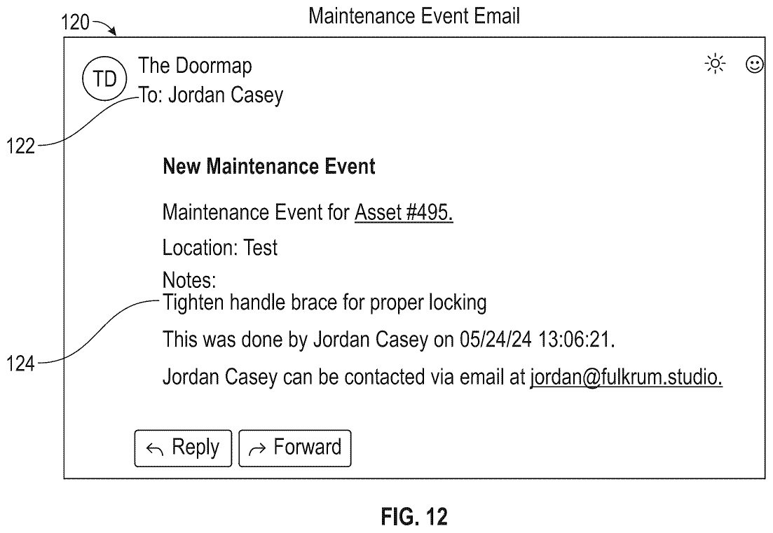

FIG. 12 is a maintenance event email 120 that is also sent when the user activates the submit selection button 108 of the maintenance event creation webpage 100. The maintenance event email 120 is sent to the email address 122 that was entered in the email address input textbox 103 of maintenance event creation webpage 100. The maintenance event email 120 include information entered into the user name input textbox 102, the location input textbox 105, and the maintenance performed input textbox 104 in the maintenance event creation webpage 100 of FIG. 10. The maintenance event email 120 could be a message other than email, e.g. text message.

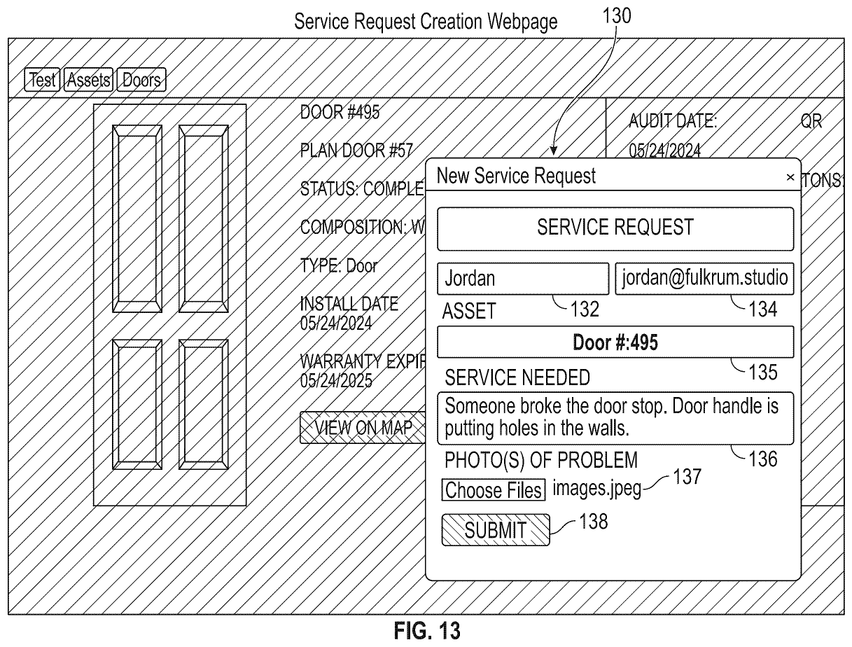

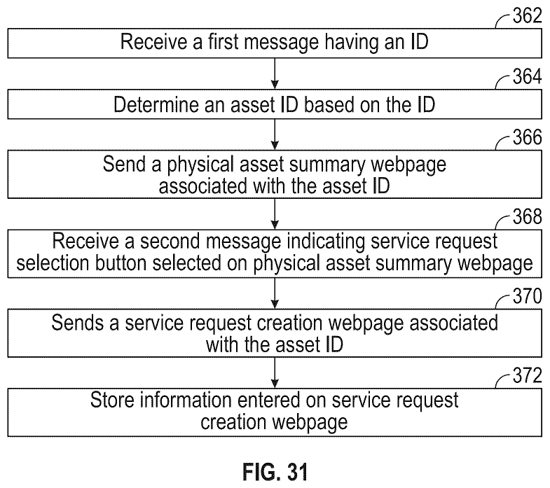

Referring to FIG. 31, again if the user scans a QR code coupled to a physical asset (e.g. door) with the remote smart device 20, the QR ID is sent to the at least one server 12 (step 362). The at least one server 12 determines an asset ID associated with the QR ID (step 364). The at least one server 12 sends the physical asset summary webpage 96 (step 366). From the physical asset summary webpage 96, the user can cause the remote smart device 20 to send to the at least one server 12 a message indicating that the service request selection button has been selected (step 368). In response, the at least one server 12 sends the service request creation webpage 130 shown in FIG. 13, which is sent by the at least one server 12 and displayed by the remote smart device 20 on the at least one display 32. The service request creation webpage 130 provides user name input textbox 132 and an email address input textbox 134, both associated with the person requesting service, an asset input textbox 135 identifying the asset for which service is requested, a service needed input textbox 136 where a user can describe the service needed, a choose files image button 137 that enables the user to upload images of the asset for which service is requested, and a submit selection button 138.

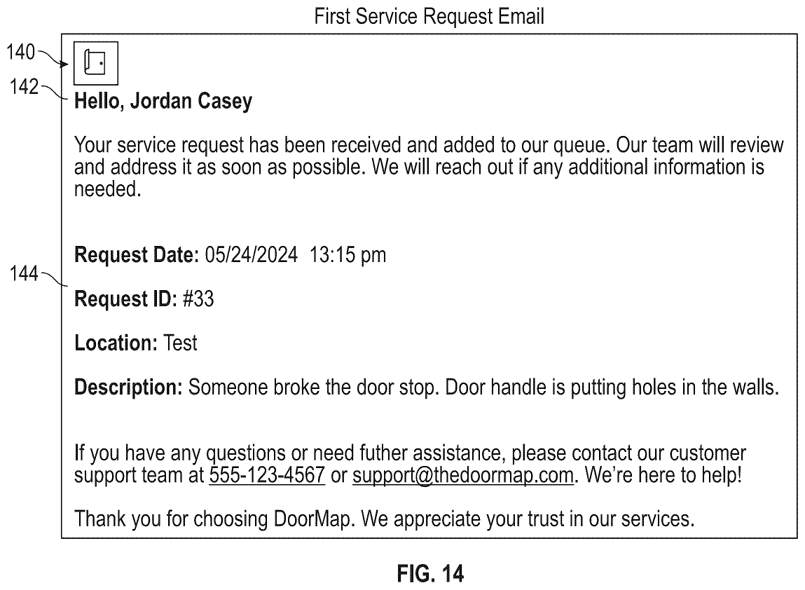

When the requesting user clicks the submit selection button 138, the at least one server 12 stores the information that was entered on the service request creation webpage 130 (step 372) and sends a first service request email 140 as shown in FIG. 14 to the requesting user. As shown, the first service request email 140 is addressed to the requesting user 142 (from user name input textbox 132 and email address input textbox 134 of service request creation webpage 130 of FIG. 13). The first service request email 140 summarizes the information entered on service request creation webpage 130 (FIG. 13). The first service request email 140 could be a message other than email, e.g. a text message.

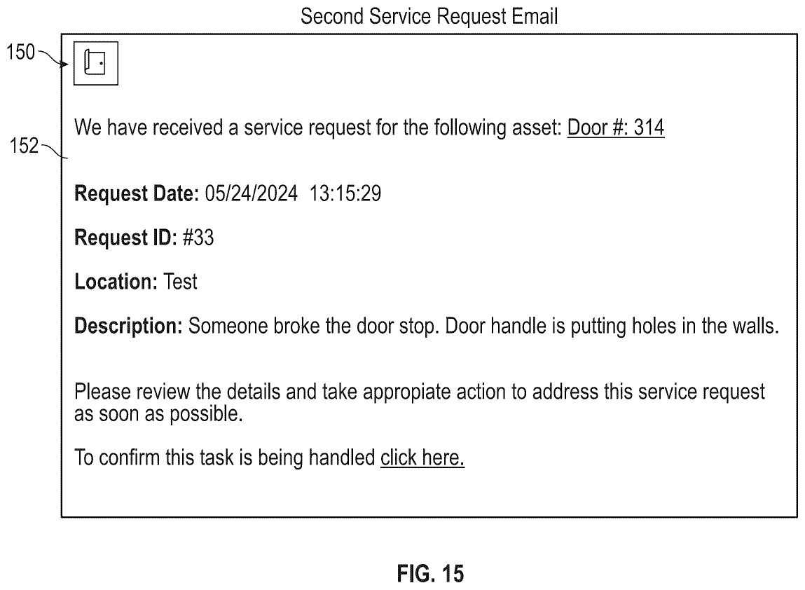

In response to the user activating the submit selection button 138, the at least one server 12 also sends a second service request email 150 as shown in FIG. 15. The second service request email 150 is sent to a service request resolution company (maintenance company) or a specific person or persons responsible for handling service requests for the assets. Again, the second service request email 150 summarizes the information entered on service request creation webpage 130 (FIG. 13). The second service request email 150 also includes a confirmation link 154 for the responding user to activate to confirm that the request has been received and will be addressed. The second service request email 150 could be a message other than email, e.g. a text message.

FIG. 16 is a physical asset table 160 stored in the at least one memory 24 of the at least one server 12 of the door management platform of FIG. 1. The physical asset table 160 includes, among other things shown, the id, the type, dimensions, composition, install date, warranty date, etc.

FIG. 17 is a QR table 164 stored in the at least one memory 24 of the at least one server 12 of the portal management platform 10 of FIG. 1. The QR table 164 correlates the Asset ID to the QR ID.

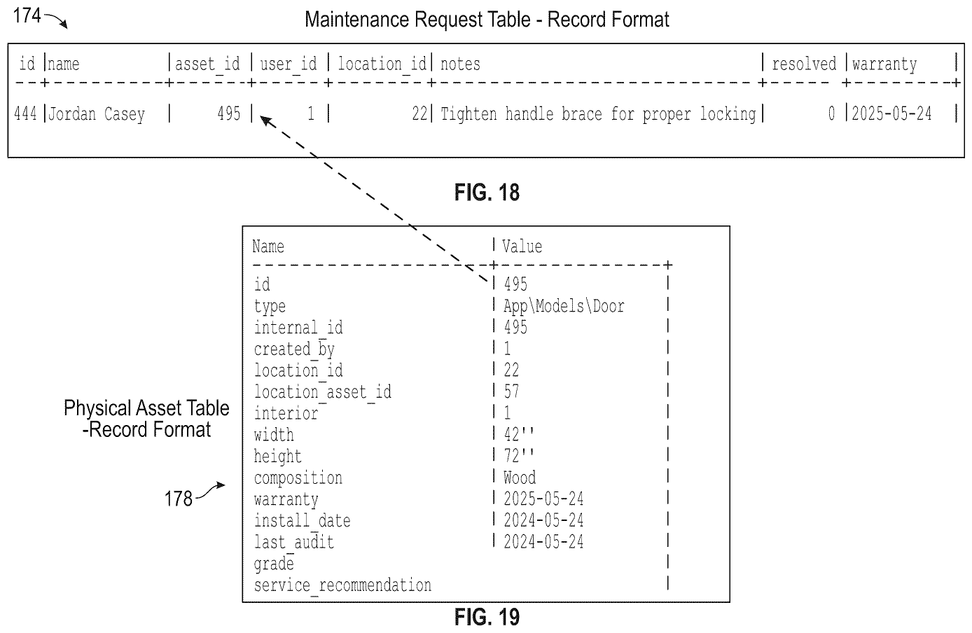

FIG. 18 is a maintenance request table 174 stored in the at least one memory 24 of the at least one server 12 of the portal management platform 10 of FIG. 1. The maintenance request table 174 includes the id, name, asset id, notes and warranty date fields, among others.

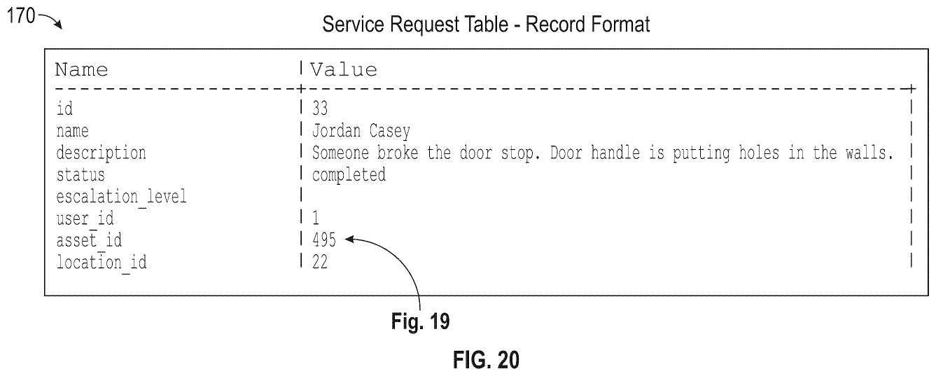

FIG. 19 is a physical asset table 178 stored in the at least one memory 24 of the at least one server 12 of the portal management platform 10 of FIG. 1. The physical asset table 178 includes the id that links to the id of the maintenance request table 174 of FIG. 18.

FIG. 20 is a service request table stored in the at least one memory 24 of the at least one server 12 of the portal management platform 10 of FIG. 1. Again, the id of the physical asset table 178 of FIG. 19 links the physical asset record to the service request record.

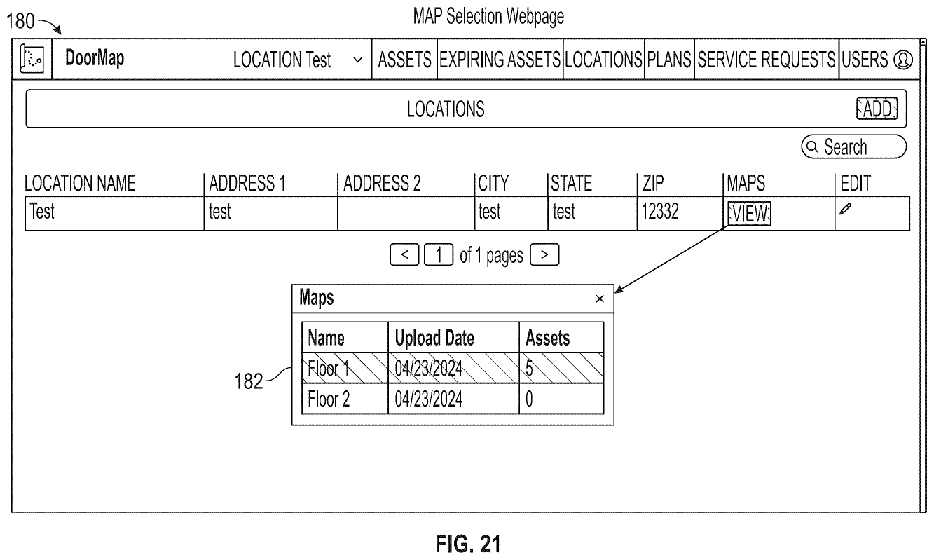

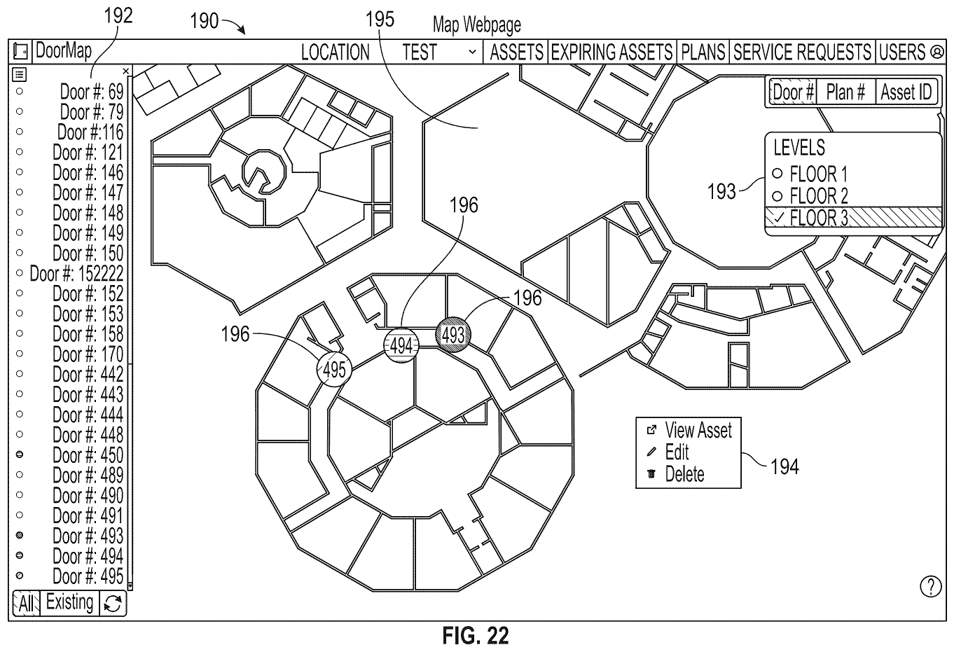

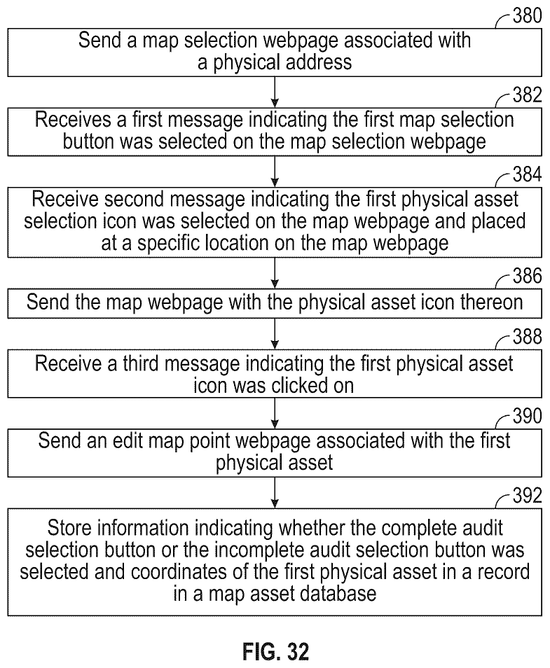

Referring also to FIG. 32, FIG. 21 is a map selection webpage 180 that can be requested by the remote smart device 20, sent in response by the at least one server 12 to the remote smart device 20 (step 32) and displayed by the remote smart device 20. The map selection webpage 180 is associated with a physical address and includes map selection buttons 182, such as for selecting one of a plurality of floors to be displayed. to the at least one server 12 receives a message that one of the map selection buttons 182 was activated (step 382). In response, the at least one server 12 sends to the remote smart device 20 a map webpage 190 shown in FIG. 22 (386).

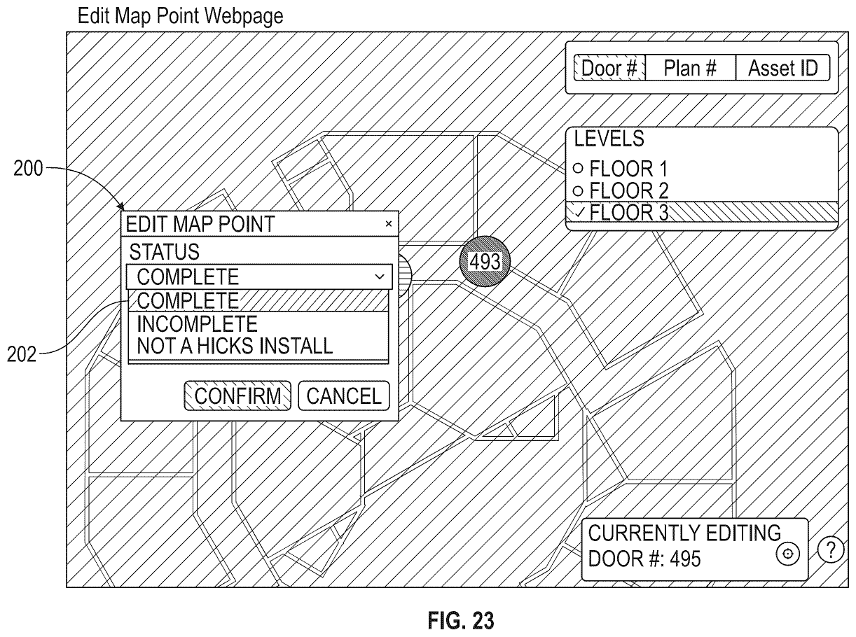

FIG. 22 is the map webpage 190 as displayed on the remote smart device 20. The map webpage 190 displays a plurality of physical asset selection buttons 192 identifying a plurality of physical assets (e.g. doors 80) at the physical address. The map webpage 190 displays a map 195 of the physical address including physical asset icons 196 at their associated locations on the map. The map webpage 190 may include a list of floors 193 that can be selected for the map webpage 190 to display. When a user clicks on one of the physical asset icons 196, a message is received by the at least one server 12. In response, the at least one server 12 sends a popup menu 194 including an edit button. When the edit button is activated the at least one server 12 sends to the remote smart device 20 the edit map point webpage 200 (step 390) shown in FIG. 23.

The physical asset icons 196 may each be one of a plurality of available colors, each indicating some general meaning. For example, green physical asset icon 196 may indicate that all is well with the associated physical asset (e.g. portal). A red physical asset icon 196 may indicate that something is wrong or that the physical asset needs a maintenance check. A blue physical asset icon 196 may indicate that the physical asset may be undergoing a construction or maintenance event (e.g it is being built or in the process of being repaired).

In the edit map point webpage 200 of FIG. 23, the user can choose to edit the selected information associated with the physical asset icon 196 that was selected, such as editing whether the physical asset is complete, not complete, or not associated with the company that installed other physical assets at that physical address. The information is stored by the at least one server 12 in the at least one memory 16 (step 392).

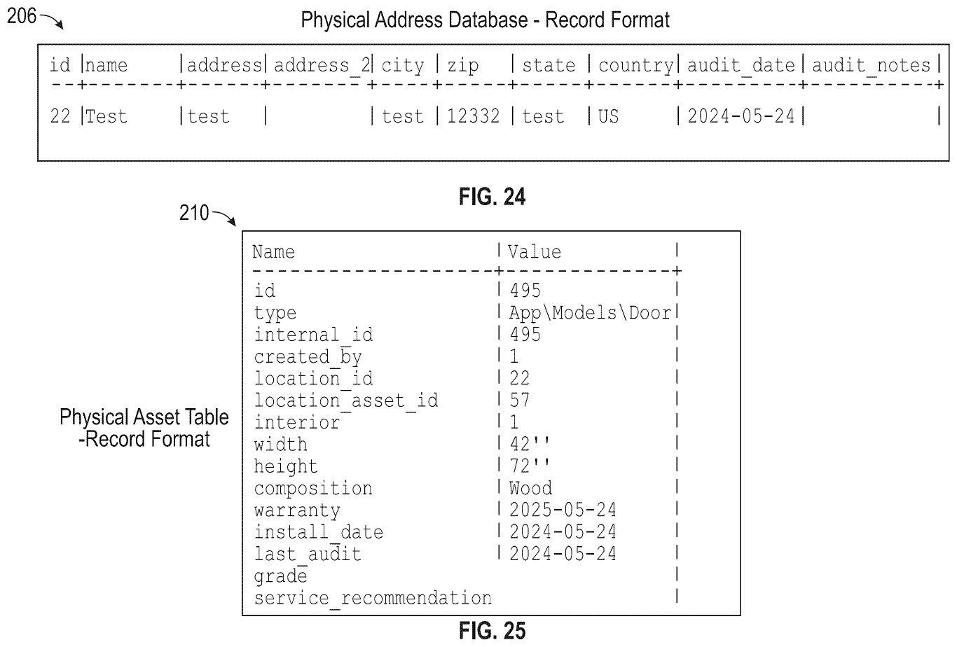

FIG. 24 is a physical address database 206 stored in the at least one memory 24 of the at least one server 12 of the portal management platform 10 of FIG. 1.

FIG. 25 is a physical address table 210 stored in the at least one memory 24 of the at least one server 12 of the portal management platform 10 of FIG. 1.

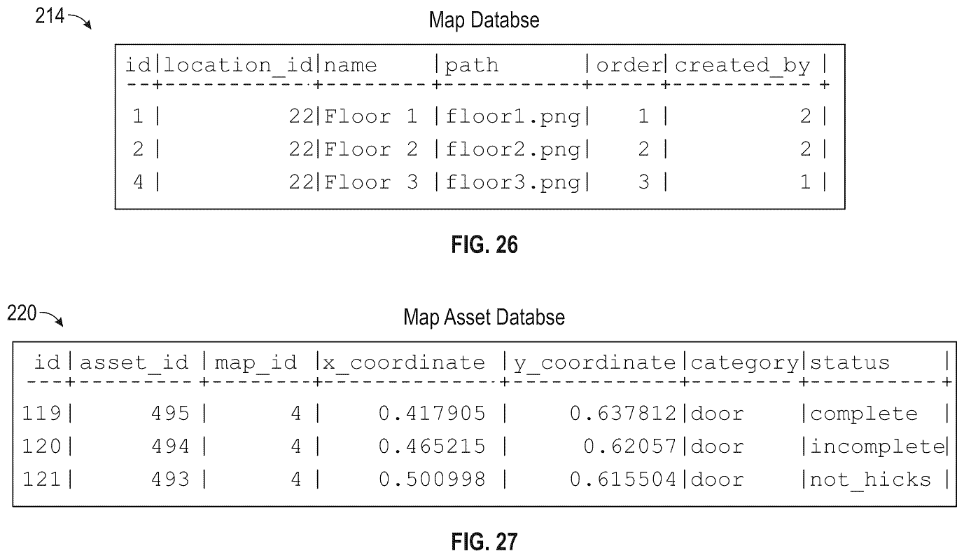

FIG. 26 is a portion of a map database 214 stored in the at least one memory 24 of the at least one server 12 of the portal management platform 10 of FIG. 1.

FIG. 27 is a map asset database 220 stored in the at least one memory 24 of the at least one server 12 of the portal management platform 10 of FIG. 1. The map asset database 220 indicates the location of physical assets on the map.

In accordance with the provisions of the patent statutes and jurisprudence, exemplary configurations described above are considered to represent preferred embodiments of the inventions. However, it should be noted that the inventions can be practiced otherwise than as specifically illustrated and described without departing from its spirit or scope. For example, although the portal management platform 10 has been described as using a webpage structure provided by the at least one server 12, it would also be within the scope of this invention to provide a dedicated app (instead of a web browser) on the remote smart device 20 that communicates with the at least one server 12.

Alphanumeric identifiers on method steps are solely for ease in reference in dependent claims and such identifiers by themselves do not signify a required sequence of performance, unless otherwise explicitly specified.

What is claimed is:

1. A system for generating a new asset record for a physical asset, wherein the physical asset is a portal, the system comprising:
at least one server sending a physical asset index webpage to a remote smart device, the physical asset index webpage having a create new asset selection button therein;
the at least one server sending a new physical asset dialogue webpage to the remote smart device when the at least one server receives a first message indicating the create new asset selection button was selected on the physical asset index webpage; the new physical asset dialogue webpage having a physical asset type input textbox, a dimension input textbox, a composition input textbox, and a save selection button;
the at least one server storing information entered into the physical asset type input textbox, the dimension input textbox, the composition input textbox of the new physical asset dialogue webpage in a new asset record in a physical asset table in a memory device, when the at least one server receives a second message indicating the save selection button was selected;
the at least one server sending a physical asset summary webpage associated with the physical asset to the remote smart device when the at least one server receives a third message indicating a selectable record on the physical asset index webpage associated with the new asset record in the physical asset table was selected on the physical asset index webpage;
the at least one server sending a QR connection webpage to the remote smart device when the at least one server receives a fourth message indicating a connect QR code selection button was selected on the physical asset summary webpage;
the at least one server receiving a fifth message having a QR ID associated with a QR code; and
the at least one server storing a new QR record in a QR table having the QR ID and an asset ID that are associated with the new asset record in a physical asset table in the memory device.

2. The system of claim 1, wherein:
the new physical asset dialogue webpage further having an install date input textbox and a warranty expiration input textbox; and
the at least one server storing information entered into the install date input textbox and the warranty expiration input textbox of the new physical asset dialogue webpage in the memory device, when the at least one server receives the second message indicating the save selection button was selected on the new physical asset dialogue webpage.

3. The system of claim 1 wherein the portal includes a door.

4. A system for generating an audit record associated with a physical asset, wherein the physical asset is a portal, the system comprising:
at least one server receiving a first message having a QR ID associated with a physical asset;
the at least one server determining an asset ID based on the QR ID when the at least one server receives the first message;
the at least one server sending a physical asset summary webpage associated with the asset ID to a remote smart device, the physical asset summary webpage having a new audit selection button therein;
the at least one server sending a physical asset specification webpage associated with the asset ID to the remote smart device when the at least one server receives a second message indicating the new audit selection button was selected on the physical asset summary webpage, the physical asset specification webpage having at least one input textbox, a choose files image button, and a next selection button therein; and
the at least one server storing information entered into the at least one input textbox of the physical asset specification webpage, and a current audit date in a record in a physical asset table in a memory device, and storing an image file selected using the choose files image button in the memory device, when the at least one server receives a third message indicating the next selection button was selected on the physical asset specification webpage.

5. The system of claim 4 wherein the portal includes a door.

6. A system for generating a maintenance record associated with a physical asset, wherein the physical asset is a portal, the system comprising:
at least one server receiving a first message having a QR ID associated with a physical asset;
the at least one server determining an asset ID based on the QR ID when the at least one server receives the first message;
the at least one server sending a physical asset summary webpage associated with the asset ID to a remote smart device, the physical asset summary webpage having a new maintenance event selection button therein;
the at least one server sending a maintenance event creation webpage associated with the asset ID to the remote smart device when the at least one server receives a second message indicating the new maintenance event selection button was selected on the physical asset summary webpage, the maintenance event creation webpage having a user name input textbox, an email address input textbox, a location input textbox, a maintenance performed input textbox, a choose files image button, and a submit selection button therein; and
the at least one server storing information entered into the user name input textbox, the email address input textbox, the location input textbox, the maintenance performed input textbox in a maintenance record in a maintenance request table in a memory device, and storing an image file selected using the choose files image button in the memory device, when the at least one server receives a third message indicating the submit selection button was selected on the maintenance event creation webpage.

7. The system of claim 6, wherein:
the maintenance event creation webpage further having a warranty expiration input textbox; and
the at least one server storing information entered into the warranty expiration input textbox in the maintenance record in the maintenance request table in the memory device.

8. The system of claim 7, wherein:
the at least one server sending a maintenance event summary webpage associated with the asset ID to the remote smart device when the third message was received by the at least one server, the maintenance event summary webpage having a date of maintenance field, a user name field indicating a name of a person who performed maintenance on the physical asset, a notes field, a warranty expiration date field, and the image file selected using the choose files image button of the maintenance event creation webpage.

9. The system of claim 6, wherein:
the at least one server sending a maintenance event email to an email address indicated in the email address input textbox of the maintenance event creation webpage when the at least one server receives the third message indicating the submit selection button was selected on the maintenance event creation webpage, the maintenance event email having information entered into the user name input textbox, the location input textbox, and the maintenance performed input textbox.

11. The system of claim 6 wherein the portal includes a door.

12. A system for creating a service request for a physical asset, wherein the physical asset is a portal, the system comprising:
at least one server receiving a first message having a QR ID associated with a physical asset;
the at least one server determining an asset ID based on the QR ID when the at least one server receive the first message;
the at least one server sending a physical asset summary webpage associated with the asset ID to a remote smart device, the physical asset webpage having a service request selection button therein;
the at least one server sending a service request creation webpage associated with the asset ID to the remote smart device when the computer servicer receives a second message indicating the service request selection button was selected on the physical asset summary webpage, the service request creation webpage having a user name input textbox, an email address input textbox, an asset input textbox, a service needed input textbox, a choose files image button, and a submit selection button therein; and
the at least one server storing information entered into the user name input textbox, the email address input textbox, the asset input textbox, the service needed input textbox in a service request record in a service request table in a memory device, and storing an image file selected using the choose files image button of the service request creation webpage in the memory device, when the at least one server receives a third message indicating the submit selection button was selected on the service request creation webpage.

13. The system of claim 12, wherein:
the at least one server sending a first service request email to an email address indicated in the email address input textbox of the service request creation webpage when the at least one server receives the third message indicating the submit selection button was selected on the service request creation webpage, the first service request email having information entered into the user name input textbox and the service needed textbox.

14. The system of claim 13, wherein:
the at least one server sending a second service request email to another email address associated with a service request resolution company when the at least one server receives the third message indicating the submit selection button was selected on the service request creation webpage, the second service request email having information entered into the service needed textbox.

15. The system of claim 12 wherein the portal includes a door.

16. A system for creating a physical asset icon on a map indicating audit status, comprising:
the at least one server sending a map selection webpage associated with a physical address to a remote smart device, the map selection webpage having a first map selection button and second map selection button therein;
the at least one server sending a map webpage to the remote smart device when the at least one server receives a first message indicating the first map selection button was selected on the map selection webpage, the map webpage having a plurality of physical asset selection buttons identifying a plurality of physical assets at the physical address, wherein each of the plurality of physical assets is a portal;
the at least one server sending the map webpage with the physical asset icon thereon when the computer servicer receives a second message indicating the first physical asset selection icon was selected on the map webpage and placed at a specific location on the map webpage, the physical asset icon being associated with a first physical asset of the plurality of physical assets on the map webpage; and
the at least one server sending an edit map point webpage associated with the first physical asset to the remote smart device when the computer servicer receives a third message indicating the first physical asset icon was clicked on, the edit map point webpage having a selection menu with a complete audit selection button, an incomplete audit selection button, and a confirm selection button; and
the at least one server storing information indicating whether the complete audit selection button or the incomplete audit selection button was selected and coordinates of the first physical asset in a record in a map asset database when the at least one server receives a fourth message indicating the confirm selection button was selected.

17. The system of claim 16 wherein each of the plurality of portals includes a door.
